(19) United States
(12) Patent Application Publication
(10) Pub. No.: US 2023/0073651 A1
(43) Pub. Date: Mar. 9, 2023

(54) FlowStop2020 Mask Attachment Devices

(71) Applicant: Daniel Lee Jensen, Fair Oaks, CA (US)

(72) Inventor: Daniel Lee Jensen, Fair Oaks, CA (US)

(21) Appl. No.: 17/464,625

(22) Filed: Sep. 1, 2021

(51) Int. Cl. A62B 18/08; A41D 13/11

(52) U.S. Cl. CPC A62B 18/084; A41D 13/1169

(57) ABSTRACT

An article of manufacture providing a face attachment devices for securing a face covering to a face according to the present invention have chin attachment device, a nose bridge attachment device, and a pair of cheek attachment devices. The chin attachment device has a pair of strips of hydrogel self-adhesive material stacked on top of each other for use about a chin. Each of the cheek attachment device having a first top and a first bottom strip of hydrogel self-adhesive material stacked on top of each other for use on a first cheek, the first top strip of hydrogel self-adhesive material being placed on top of a rectangular cheek inserted structure between the first top and first bottom strip of hydrogel self-adhesive material. The nose bridge attachment device having a nose bridge top and a nose bridge bottom strip of hydrogel self-adhesive material stacked on top of each other for use on a nose bridge, the nose bridge top strip of hydrogel self-adhesive material being placed on top of a pair of triangular-shaped structure between the nose bridge top and nose bridge bottom strip of hydrogel self-adhesive material.

### CROSS-REFERENCE TO RELATED APPLICATION

This application claims priority to U.S. Patent Application No. 63/073,031, titled “FlowStop 2020,” and filed on Sep. 1, 2020. The entire application is incorporated herein by reference in its entirety.

### TECHNICAL FIELD

This application relates in general to an article of manufacture for providing personal protective devices, and more specifically, to an article of manufacture providing a face attachment devices for securing a face covering to a face.

### BACKGROUND

In the past year and a half, over 600,000 Americans have died as a result of contracting the Covid-19 virus. Covid-19 is an airborne/aerosol illness and can be inhaled through unfiltered open airways. Existing masks warn by individuals have a limitation that they typically slipping down off nose/face providing a loose fitting mask that includes a large areas of open airflow. Effective masks need to be held in place on the face to be effective against Covid-19 aerosol infection. Additionally, loose fitting masks have a further limitation in which exhaled breath for user directs warm, moist air onto eyeglasses resulting in the lens fogging up.

Therefore, a need exists for an article of manufacture providing a face attachment devices for securing a face covering to a face. The present invention attempts to address the limitations and deficiencies in prior solutions according to the principles and example embodiments disclosed herein.

### SUMMARY

In accordance with the present invention, the above and other problems are solved by providing an article of manufacture providing a face attachment devices for securing a face covering to a face according to the principles and example embodiments disclosed herein.

In one embodiment, the present invention is an article of manufacture for or providing a face attachment devices for securing a face covering to a face. The face attachment devices include a chin attachment device, a nose bridge attachment device, and a pair of cheek attachment devices. The chin attachment device has a pair of strips of hydrogel self-adhesive material stacked on top of each other for use about a chin. Each of the cheek attachment device having a first top and a first bottom strip of hydrogel self-adhesive material stacked on top of each other for use on a first cheek, the first top strip of hydrogel self-adhesive material being placed on top of a rectangular cheek inserted structure between the first top and first bottom strip of hydrogel self-adhesive material. The nose bridge attachment device having a nose bridge top and a nose bridge bottom strip of hydrogel self-adhesive material stacked on top of each other for use on a nose bridge, the nose bridge top strip of hydrogel self-adhesive material being placed on top of a pair of triangular-shaped structure between the nose bridge top and nose bridge bottom strip of hydrogel self-adhesive material.

In another aspect of the present invention, the triangular-shaped structures between the nose bridge top and the nose bridge bottom strip of hydrogel self-adhesive material are between 0.4″ and 0.85″ high.

In another aspect of the present invention, the triangular-shaped structures between the nose bridge top and the nose bridge bottom strip of hydrogel self-adhesive material are between 3″ and 4″ wide.

In another aspect of the present invention, the triangular-shaped structures between the nose bridge top and the nose bridge bottom strip of hydrogel self-adhesive material being located adjacent to each other along the nose bridge bottom strip of hydrogel self-adhesive material.

In another aspect of the present invention, the triangular-shaped structures between the nose bridge top and the nose bridge bottom strip of hydrogel self-adhesive material being located separated from each other along the nose bridge bottom strip of hydrogel self-adhesive material by between 0.30″ and 1.25″.

In another aspect of the present invention, the face attachment devices may be removed from a face covering, washed using an electrolyte spray, and attached to a new face covering.

In another aspect of the present invention, the nose bridge attachment device is used alone to prevent glasses from fogging while holding the face covering to the skin.

In another aspect of the present invention, a pair of cheek attachment devices being used simultaneously on a single face covering.

In another aspect of the present invention, the nose bridge attachment device is further used with the pair of cheek attachment device.

In another aspect of the present invention, the chin attachment device is further used with the pair of cheek attachment devices and the nose bridge attachment devices.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate example embodiments of an article of manufacture providing a face attachment devices for securing a face covering to a face according to the present invention.

FIGS. 2a-c illustrates different sizes of an article of manufacture providing a face attachment devices for securing a face covering to a face according to the present invention.

FIGS. 3a-c illustrate different sizes of a hydrogel strips used in an article of manufacture providing a face attachment devices for securing a face covering to a face according to the present invention.

FIGS. 4a-c illustrate different sizes of a cheek attachment device used in an article of manufacture providing a face attachment devices for securing a face covering to a face according to the present invention

FIGS. 5a-i illustrate different sizes of a first embodiment of a nose bridge attachment device used in an article of manufacture providing a face attachment devices for securing a face covering to a face according to the present invention.

FIGS. 6a-f illustrate different sizes of an embodiment of a separated nose bridge attachment device used in an article of manufacture providing a face attachment devices for securing a face covering to a face according to the present invention.

FIGS. 7a-c illustrate different sizes of a third embodiment of a chin attachment device used in an article of manufacture providing a face attachment devices for securing a face covering to a face according to the present invention.

FIGS. 8a-b illustrate different sizes of a third embodiment of a chin attachment device used in an article of manufacture providing a face attachment devices for securing a face covering to a face according to the present invention.

### DETAILED DESCRIPTION

This application relates in general to an article of manufacture for providing personal protective devices, and more specifically, to an article of providing a face attachment devices for securing a face covering to a face according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual,” and “user” refer to an entity, e.g., a human, using an article of manufacture providing a face attachment devices for securing a face covering to a face according to the present invention. The term user herein refers to one or more users.

The term “invention” or “present invention” refers to the invention being applied for via the patent application with the title “FlowStop2020 Mask Attachment Devices.” Invention may be used interchangeably with any face covering and mask.

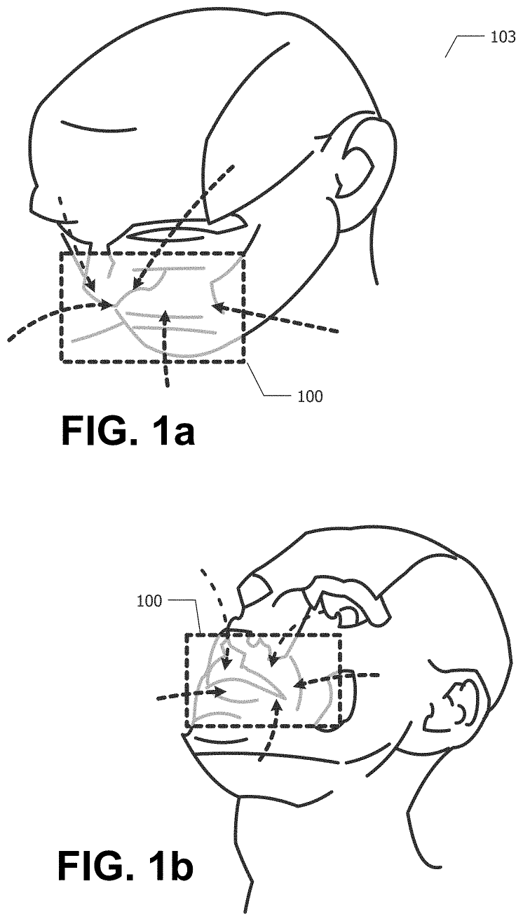

In general, the present disclosure relates an article of manufacture providing a face attachment devices for securing a face covering to a face according to the present invention. To better understand the present invention, FIGS. 1a-b illustrate example embodiments of an article of manufacture providing a face attachment devices for securing a face covering to a face according to the present invention. A mask 100 may be worn about a user's nose and mouth and is typically secures with attachment strings 101a-b about the user's ears or head. The mask 100 may contain various areas about its sides that may become positioned to allow significant airflow to pass around the mask as the user breathes, thus defeating the purpose of wearing the mask. The present invention attempts to address these limitations of the mask 100 and reduce the available space between the mask 100 and the user's face as disclosed herein.

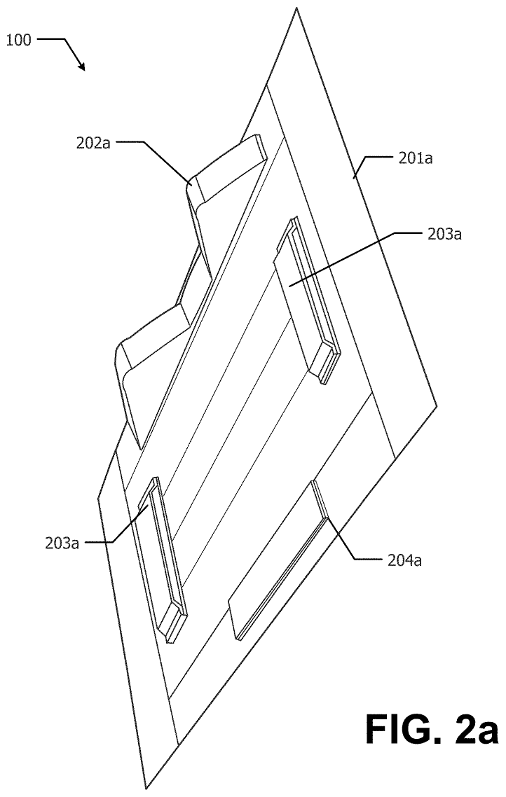

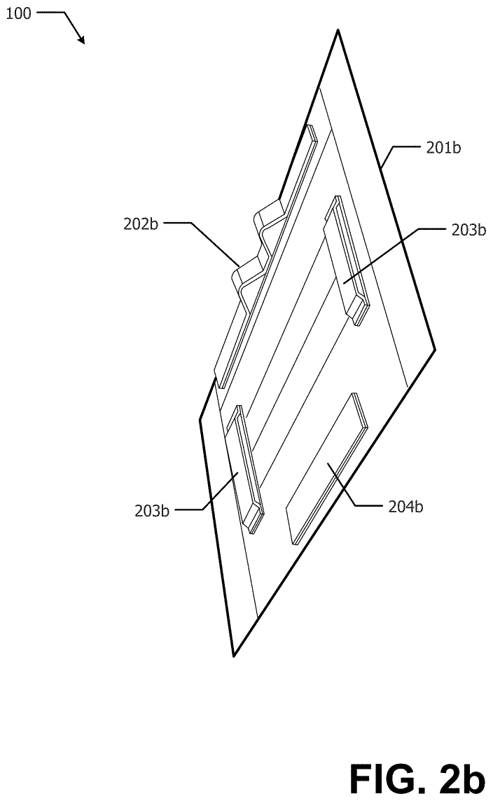

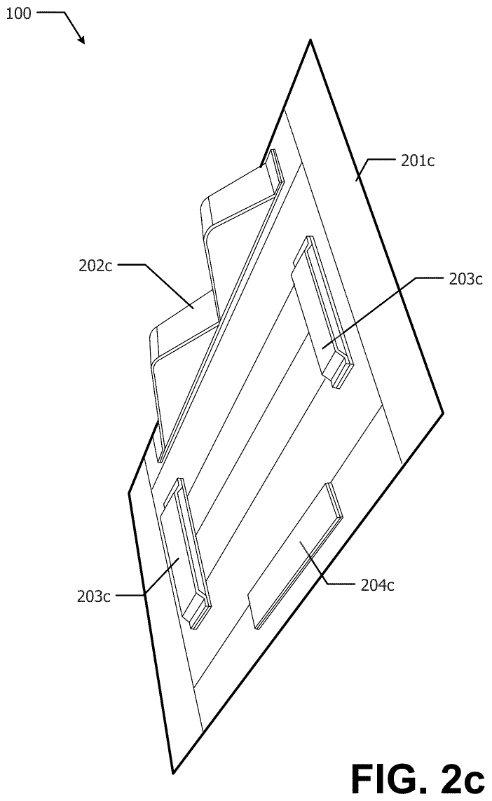

FIGS. 2a-c illustrates different sizes of an article of providing a face attachment devices for securing a face covering to a face according to the present invention. FIG. 2a shows asset of large sized attachment device 202a-202d having a separated nose bridge attachment 202a. The mask 100a comprises a mask material layer 201 having a nose bridge attachment device 202a, a pair of cheek attachment devices 203a, and a chin attachment device 204a. The mask material layer 201a may comprise any mask material including cloth, paper, and specialized filter material used in personal protective devices. The addition of the attachment devices 202a-204a to a mask material permits a user to wear a typical mask while significantly reducing the about of air reaching the user's nose and mouth.

The nose bridge attachment device 202a, the pair of cheek attachment devices 203a, and the chin attachment device 204a are attached to the mask material layer 201a about its edge to secure the mask to a user. The use of multiple attachments permits a person to place the attachments onto the mask material layer 201a in locations where the mask is most comfortable. Alternatively, a user may only wear the nose bridge attachment device 202a to stop foggy glasses. The attachment devices 202a-204a may be made in different sizes and designs as disclosed herein to aid in providing users both comfort and significantly reduced airflow around the edges of a mask.

Similar to FIG. 2a, FIG. 2b shows a child-sized mask 100b comprising mask material 201b, a set of child-sized attachment device 202a-204a having a separated nose bridge attachment 202b. The child-sized mask 201b further comprises a pair of child-sized cheek attachment devices 203b and a child-sized chin attachment device 204b.

Additionally, FIG. 2c shows an adult-sized mask 100c comprising mask material 201a, a set of adult-sized attachment device 202c-204c having a connected nose bridge attachment 202c. The adult-sized mask 201c further comprises a pair of child-sized cheek attachment devices 203c and a child-sized chin attachment device 204c.

The nose bridge attachment device 202a-c and the pair of cheek attachment devices 203a-c are 2 layers of hydrogel that is 0.045″ thick. There are hollow triangle and rectangular shapes with universal 0.01″ wall thickness between the 2 hydrogels. It will be made of TPE'S or a hypoallergenic material/rubber.

The nose bridge attachment devices 202a-c, the pair of cheek attachment devices 203a-c, and the chin attachment device 204a-c are washable with Electrolyte spray allowing use of the attachment devices for over 11 months if properly cared for. All of the attachment devices 202a-c to 204a-c should not be left submerged in water as the attachments 202a-c to 204a-c will absorb any liquids that may damage product. The nose bridge attachment device 202a-c, the pair of cheek attachment devices 203a-c, and the chin attachment device 204a-c are hypoallergenic for sensitive skin.

The hydrogel is self-adhesive material and absorbs water. When dried, the adhesive is strong. These properties allow the hydrogel to be used to attach to both a mask or face covering and to a user's face to hold the mask in place close to the skin to eliminate larger gaps that permit unwanted airflow to the user's nose and mouth. Wash by rinsing off the hairs and fuzz that sticks to the Hydrogel adhesive. The attachment devices are intended to attach to the user's skin. Hydrogel is used in medical field in many uses. The material is hypoallergenic and bonds well with any material except silicone. The attachment fills the opening without needing to bend the mask.

The nose bridge attachment device 202a-c, the pair of cheek attachment devices 203a-c, and the chin attachment device 204a-c are transferable repeatedly to a new clean mask material 201a-c. Each of the attachment devices 202a-c to 204a-c are wet with electrolytes spray that a user may rub into the attachment devices 202a-c to 204a-c before allowing the devices to sit for approximately 2 minutes before attaching each device to new mask material layer. If the attachment devices 202a-c to 204a-c loses the stickiness, the devices should regain the ability to attach to a mask material layer after cleaning.

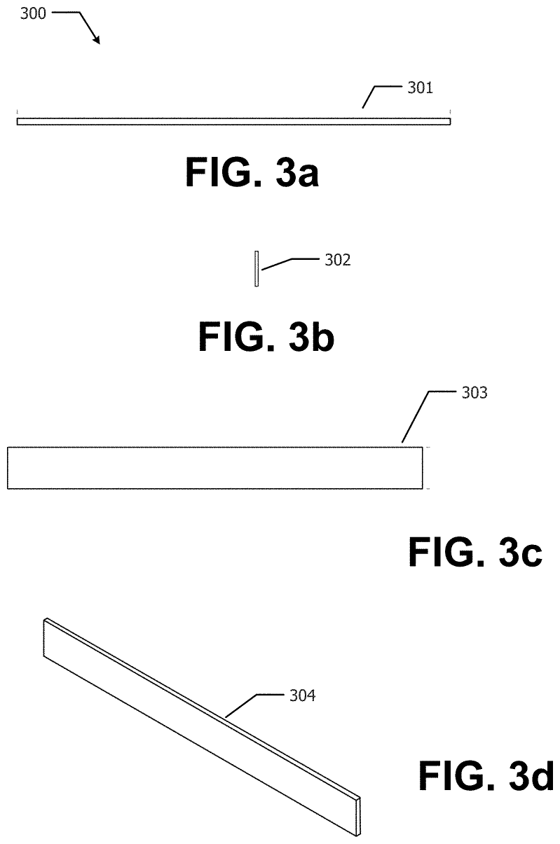

FIGS. 3a-c illustrate different sizes of a hydrogel strips used in an article of manufacture providing a face attachment devices for securing a face covering to a face according to the present invention. Each of the attachment devices 202a-c to 204a-c of FIGS. 2a-c are constructed from multiple strips of hydrogel material of various sizes as shown in FIGS. 3a-c. A pair of long strips of hydrogel 300 are applied on top of each other with a pair of triangle inserts to form the nose bridge attachment devices 202a-c. A pair of shorter strips of hydrogel 300 are applied on top of each other with a small rectangular insert to make each of the pair of cheek attachment devices 203a-c. A stacked pair of long strips of hydrogel are used to make the chin attachment devices. Each of these strips of hydrogel may be cut from a common sheet of hydrogel and assembled as disclosed herein. Once constructed, these assembles become the above attachment devices that may be place onto a mask or other face covering to wear by the user. Table 1 below states the example dimensions of hydrogel strips that may be used in a preferred embodiments of the present invention. The dimensions may vary in length and width to correspond to a length used for the various cheek, nose bridge, and chin attachment devices disclosed herein.

TABLE 1
Hydrogel Strip Dimensions (inches)

| Size | Length | Width | Thickness |
|---|---|---|---|
| Large | 7.50 | 0.75 | 0.045 |
| Medium | 6.50 | 0.50 | 0.045 |
| Kid | 5.0 | 0.45 | 0.045 |

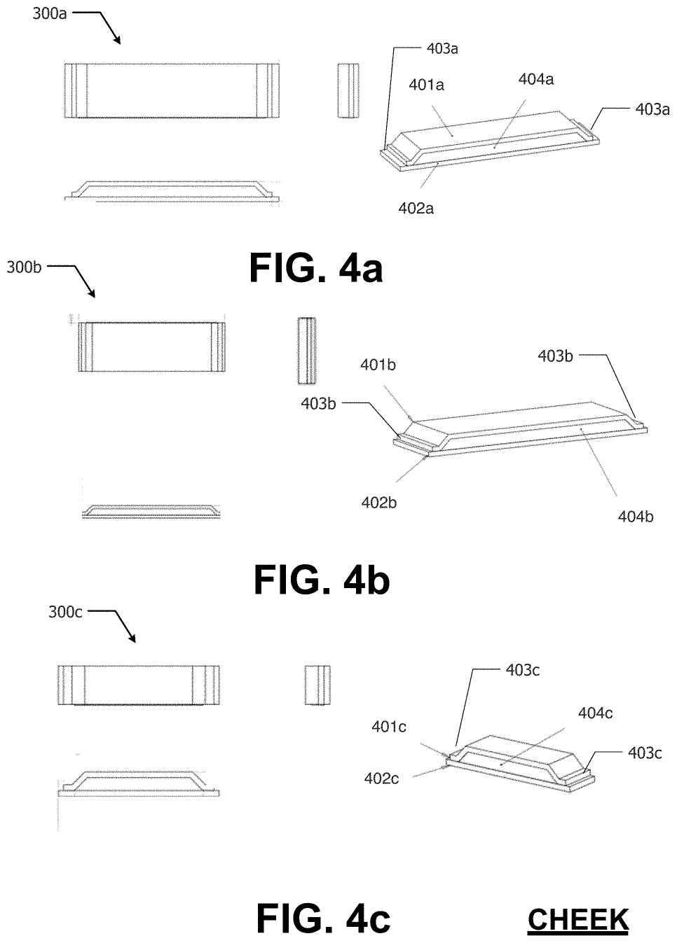

FIGS. 4a-c illustrate different sizes of a cheek attachment device used in an article of manufacture providing a face attachment devices for securing a face covering to a face according to the present invention. The cheek attachment devices 300a-c are shown in three sizes in a preferred embodiment that may be used by different users to obtain the most comfortable mask. For each of the different sized cheek attachment devices 300a-c as shown in FIGS. 3a-c, a top view, a side view, and end view, and a perspective view of the devices are shown in each Fig. The dimensions of the different cheek attachment devices 300a-c are contained within Table 1. Other sizes and proportions of the cheek attachment device 202 may be used consistent with the present invention as recited within the attached claims.

TABLE 2
Cheek Attachment Device Dimensions (inches)

| | | | | Edge | |
|---|---|---|---|---|---|
| Size | Length | Width | Height | Width | Thickness |
| Large - FIG. 4a | 2.25 | 0.75 | 0.19 | 0.13 | 0.09 |
| Medium - FIG. 4b | 2.0 | 0.50 | 0.19 | 0.13 | 0.09 |
| Kid - FIG. 4c | 1.25 | 0.30 | 0.19 | 0.13 | 0.09 |

Each of the cheek attachment devices 300a-c are made of a top layer 301a-c coupled to a bottom layer 302a-c with opposite ends of the top and bottom layers being joined along ends of the layers for a distance of an edge width 303a-c. A center layer 304a-c of thermoplastic elastomers is located between the top layer 301a-c and the corresponding bottom layer 302a-c. An underside surface of the bottom layer 302a-c attaches to the mask material layer 201 using self-adhesive hydrogel.

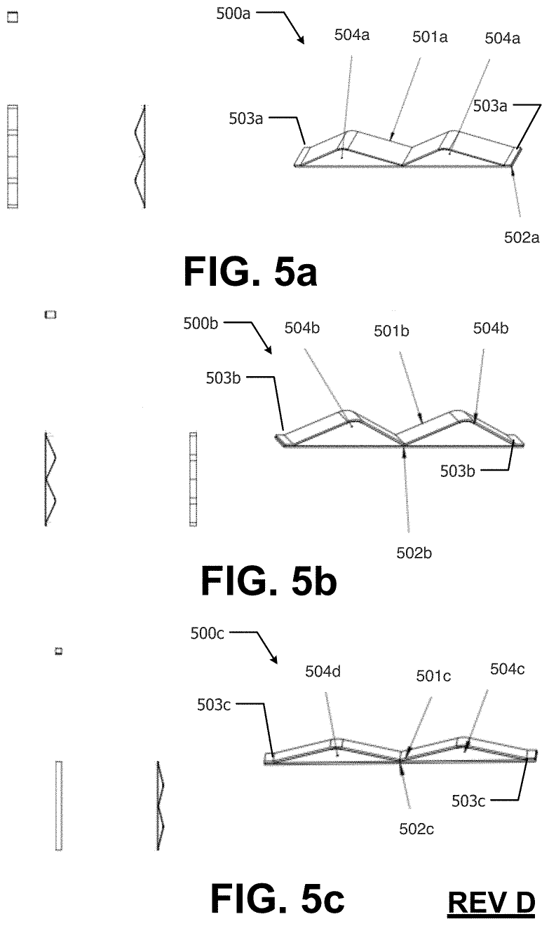

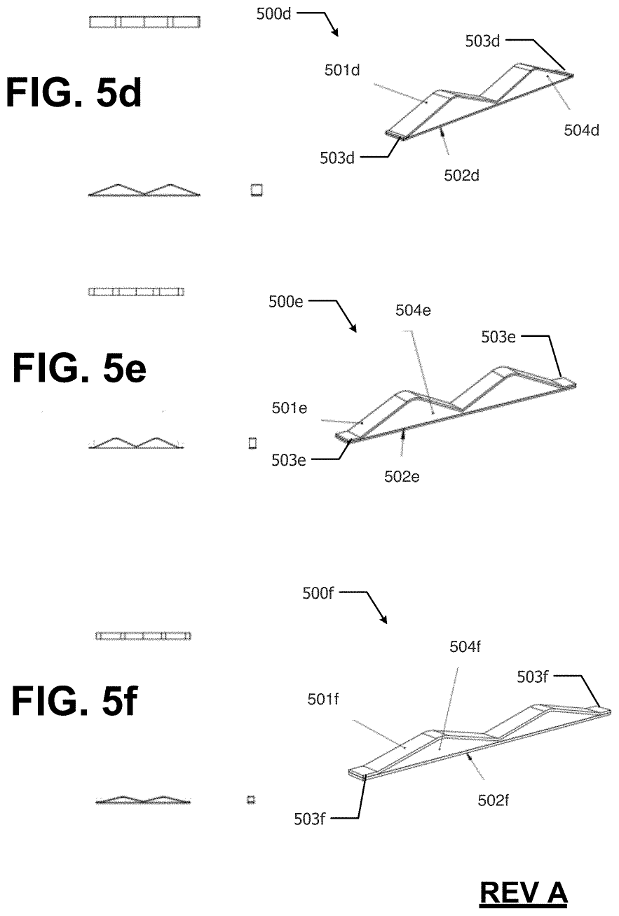

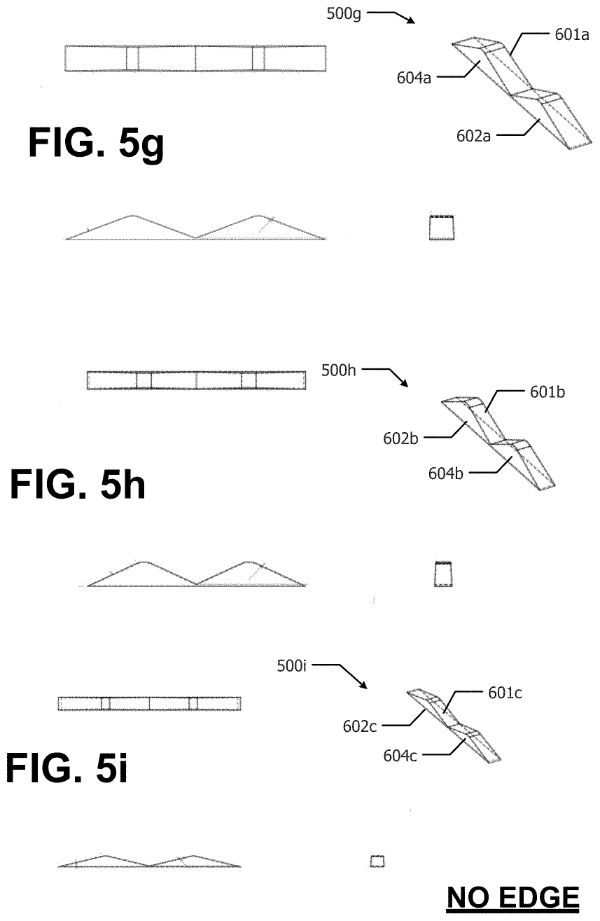

FIGS. 5a-i illustrate different sizes of a first embodiment of a nose bridge attachment device used in an article of manufacture providing a face attachment devices for securing a face covering to a face according to the present invention. The three sizes of the first embodiment of the nose bridge attachment devices 500a-i are shown in three sizes in a preferred embodiment that may be used by different users to obtain the most comfortable mask. For each of the different sized nose bridge attachment devices 500a-i as shown in FIGS. 5a-i, a top view, a side view, and end view, and a perspective view of the devices are shown in each Fig. These nose bridge attachment device are constructed with a pair of triangular-shaped structures that are not separated as the adjoining ends of the triangles are in contact with each other. Because the pair of triangular-shaped structures are placed between two hydrogel strips, two different lengths for the hydrogel strips are needed for the nose bridge attachment devices. A longer strip of hydrogel is used to cover the top surfaces of the pair of triangular-shaped structures providing the top surface that attached to the user's skin. A shorter strip of hydrogel is used to provide the base of the nose bridge attachment devices providing the surface that attached to the mask material or other face covering. The dimensions of the different nose bridge attachment device 500a-i are contained within Table 3. Other sizes and proportions of the cheek attachment device 500a-i may be used consistent with the present invention as recited within the attached claims.

TABLE 3
Connected Nose Bridge Attachment Device Dimensions (inches)

| | | | | | Edge | | |
|---|---|---|---|---|---|---|---|
| Embodiment | Size | Length | Width | Height | Width | Thickness | Separation |
| Rev D - FIG. 5a | Large | 8 under | 0.75 | 0.75 | 0.25 | 0.01 | 0 |
| | | 8.82 | | | | | |
| FIG. 5b | Medium | 7 under | 0.45 | 0.72 | 0.25 | 0.01 | 0 |
| | | 7.56 | | | | | |
| FIG. 5c | Kid | 6 under | 0.40 | 0.35 | 0.2 | 0.01 | 0 |
| | | 6.14 | | | | | |
| Rev A - FIG. 5d | Large | 8 under | 0.748 | 0.806 | 0.25 | 0.01 | 0 |
| | | 8.82 | | | | | |
| FIG. 5e | Medium | 7 under | 0.5 | 0.789 | 0.25 | 0.01 | 0 |
| | | 7.56 | | | | | |
| FIG. 5f | Kid | 6 under | 0.4 | 0.425 | 0.20 | 0.01 | 0 |
| | | 6.14 | | | | | |
| No Edge - FIG. 5g | Large | 8 under | 0.75 | 0.806 | 0 | 0.01 | 0 |
| | | 8.82 | | | | | |
| FIG. 5h | Medium | 7 under | 0.45 | 0.789 | 0 | 0.01 | 0 |
| | | 7.56 | | | | | |
| FIG. 5i | Kid | 6 under | 0.40 | 0.425 | 0 | 0.01 | 0 |
| | | 6.14 | | | | | |

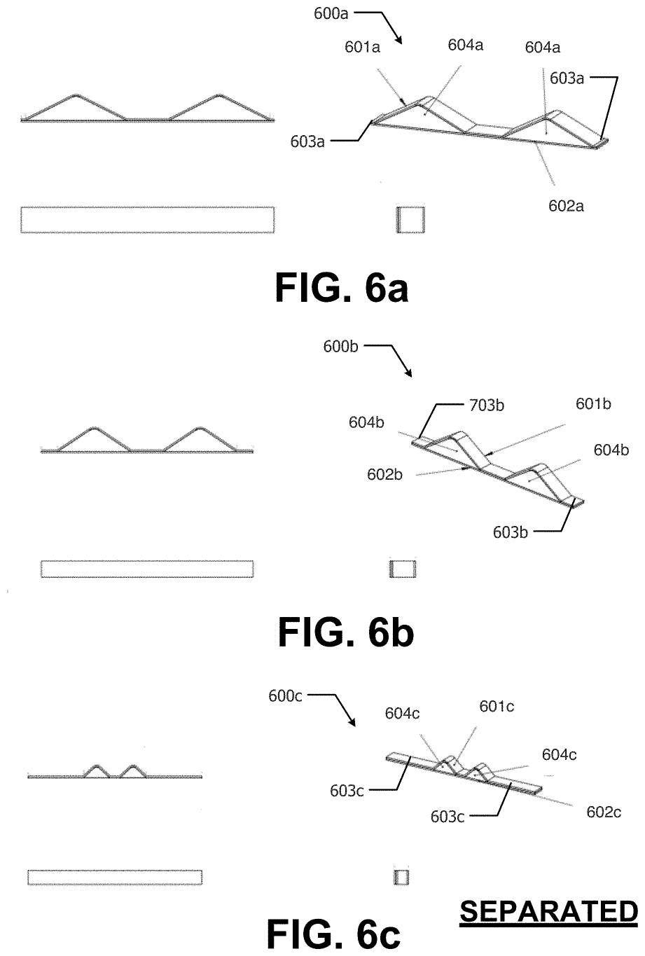

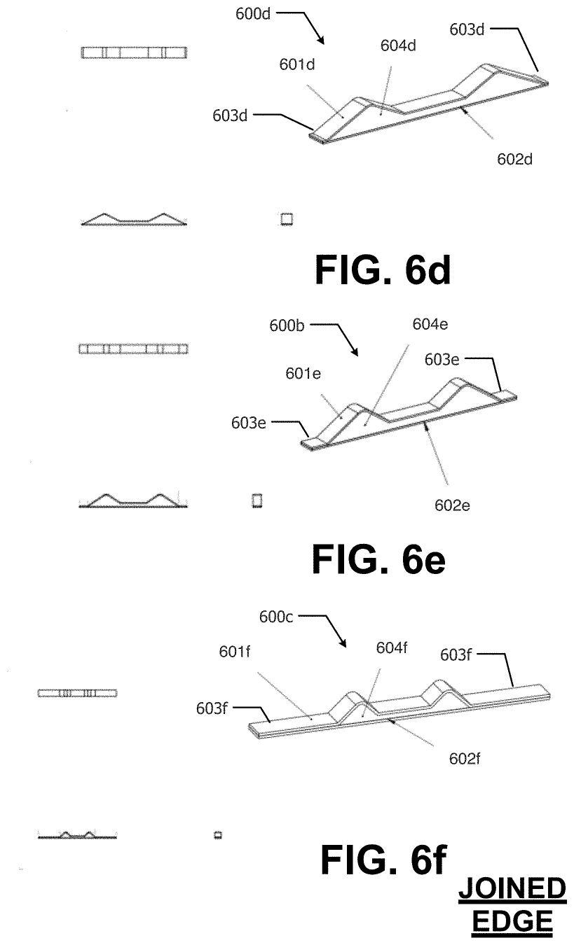

FIGS. 6a-f illustrate different sizes of a second embodiment of a nose bridge attachment device used in an article of manufacture providing a face attachment devices for securing a face covering to a face according to the present invention. The three sizes of the second embodiment of the nose bridge attachment devices 600a-c are shown in three sizes in a preferred embodiment that may be used by different users to obtain the most comfortable mask. For each of the different sized nose bridge attachment devices 600a-c as shown in FIGS. 6a-c, a top view, a side view, and end view, and a perspective view of the devices are shown in each Fig. These nose bridge attachment device 500a-c are constructed with a pair of triangular-shaped structures that are separated as the adjoining ends of the triangles are positioned with a strip of hydrogel in between each of them at the center of the nose bridge attachment devices 600a-c. The dimensions of the different nose bridge attachment device 600a-i are contained within Table 4. Other sizes and proportions of the cheek attachment device 600a-c may be used consistent with the present invention as recited within the attached claims.

TABLE 4
Separated Nose Bridge Attachment Device Dimensions (inches)

| | | | | | Edge | | |
|---|---|---|---|---|---|---|---|
| Embodiment | Size | Length | Width | Height | Width | Thickness | Separation |
| Separated - FIG. 6a | Large | 7.50 under | 0.75 | 0.81 | 0.125 | 0.01 | 1.25 |
| | | 8.16 | | | | | |
| FIG. 6b | Medium | 6.50 under | 0.5 | 0.79 | 0.50 | 0.01 | 1.0 |
| | | 7.40 | | | | | |
| FIG. 6c | Kid | 5.0 under | 0.4 | 0.40 | 1.6 | 0.01 | 0.30 |
| | | 5.48 | | | | | |
| Joined Edge - FIG. 6d | Large | 7.50 under | 0.75 | 0.81 | 0.125 | 0.01 | 0 |
| | | 8.16 | | | | | |
| FIG. 6e | Medium | 6.50 under | 0.5 | 0.79 | 0.50 | 0.01 | 0 |
| | | 7.40 | | | | | |
| FIG. 6e | Kid | 5.0 under | 0.4 | 0.403 | 1.375 | 0.01 | 0 |
| | | 5.48 | | | | | |

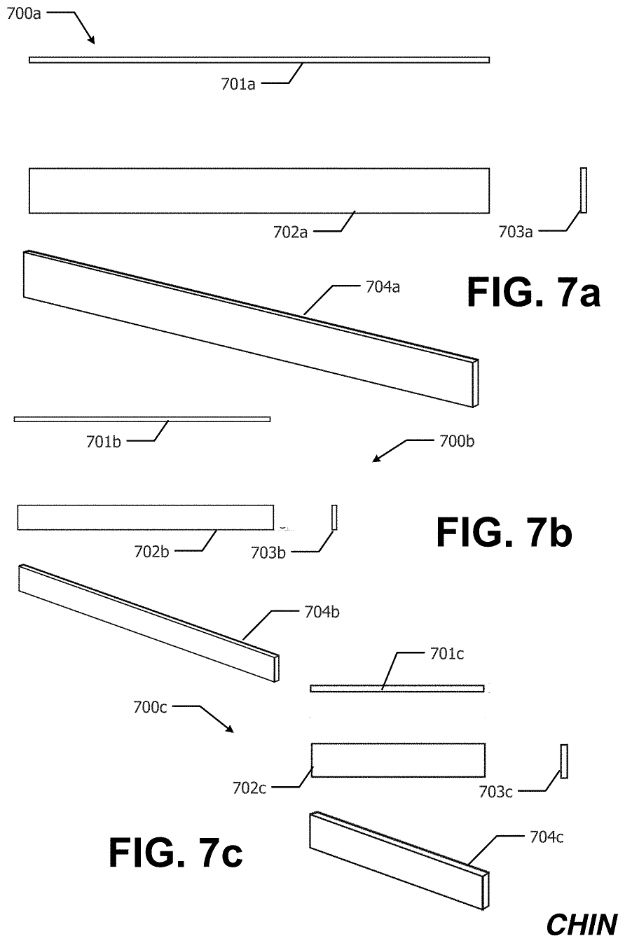

FIGS. 7a-c illustrate different sizes of an embodiment of a chin attachment device used in an article of manufacture providing a face attachment devices for securing a face covering to a face according to the present invention. The three sizes of the third embodiment of the chin attachment device 700a-c are shown in three sizes in a preferred embodiment that may be used by different users to obtain the most comfortable mask. For each of the different sized chin attachment device 700a-c as shown in FIGS. 7a-c, a top view, a side view, and end view, and a perspective view of the devices are shown in each Fig. A chin attachment device 700a-c are constructed using 2 layers of hydrogel sheet material.

TABLE 5
Chin Attachment Device Dimensions (inches)

| Size | Length | Width | Thickness |
|---|---|---|---|
| Large | 3.0 | 0.30 | 0.09 |
| Medium | 2.0 | 0.20 | 0.09 |
| Kid | 1.0 | 0 . . . 20 | 0.09 |

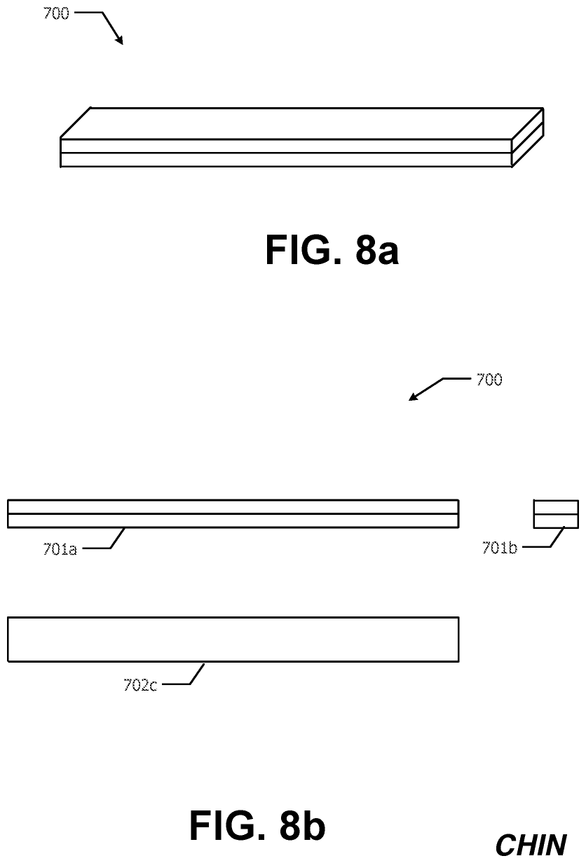

FIGS. 8a-b illustrate different views of an embodiment of a chin attachment device used in an article of manufacture providing a face attachment devices for securing a face covering to a face according to the present invention. The three sizes of the third embodiment of the chin attachment device 800 are shown in a single size as they have the same 2 strip configuration with the only differences being in the dimensions in a preferred embodiment that may be used by different users to obtain the most comfortable mask. For each of the different sized chin attachment device 700, as shown in FIG. 7b, a top view 801c, a side view 801a and end view 801b are provided. A perspective view of the devices is shown in FIG. 8a. A chin attachment device 800 are constructed using 2 layers of hydrogel sheet material.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a face attachment devices for securing a face covering to a face, the face attachment devices comprise:
a chin attachment device having a pair of strips of hydrogel self-adhesive material stacked on top of each other for use about a chin;
a cheek attachment device having a first top and a first bottom strip of hydrogel self-adhesive material stacked on top of each other for use on a first cheek, the first top strip of hydrogel self-adhesive material being placed on top of a rectangular cheek inserted structure between the first top and first bottom strip of hydrogel self-adhesive material;
a nose bridge attachment device having a nose bridge top and a nose bridge bottom strip of hydrogel self-adhesive material stacked on top of each other for use on a nose bridge, the nose bridge top strip of hydrogel self-adhesive material being placed on top of a pair of triangular-shaped structure between the nose bridge top and nose bridge bottom strip of hydrogel self-adhesive material.

2. The face attachment devices according to claim 1, wherein the triangular-shaped structures between the nose bridge top and the nose bridge bottom strip of hydrogel self-adhesive material are between 0.4″ and 0.85″ high.

3. The face attachment devices according to claim 2, wherein the triangular-shaped structures between the nose bridge top and the nose bridge bottom strip of hydrogel self-adhesive material are between 3″ and 4″ wide.

4. The face attachment devices according to claim 3, wherein the triangular-shaped structures between the nose bridge top and the nose bridge bottom strip of hydrogel self-adhesive material being located adjacent to each other along the nose bridge bottom strip of hydrogel self-adhesive material.

5. The face attachment devices according to claim 3, wherein the triangular-shaped structures between the nose bridge top and the nose bridge bottom strip of hydrogel self-adhesive material being located separated from each other along the nose bridge bottom strip of hydrogel self-adhesive material by between 0.30″ and 1.25″.

6. The face attachment devices according to claim 1, wherein the face attachment devices may be removed from a face covering, washed using an electrolyte spray, and attached to a new face covering.

7. The face attachment devices according to claim 6, wherein the nose bridge attachment device is used alone to prevent glasses from fogging.

8. The face attachment devices according to claim 6, wherein a pair of cheek attachment devices being used simultaneously on a single face covering.

9. The face attachment devices according to claim 8, wherein the nose bridge attachment device is further used with the pair of cheek attachment devices.

10. The face attachment devices according to claim 9, wherein the chin attachment device is further used with the pair of cheek attachment devices and the nose bridge attachment devices.
